(19) United States
(12) Patent Application Publication
(10) Pub. No.: US 2009/0156307 A1
(43) Pub. Date: Jun. 18, 2009

(54) VIDEO GAME CONTROLLER WITH A FAN

(76) Inventors: Jorge Cristian Donoso Aguirre, Santiago (CL); Jose Nicolas Muzard Trotter, Santiago (CL)

Correspondence Address: GREENBERG TRAURIG, LLP, MET LIFE BUILDING, 200 PARK AVENUE, NEW YORK, NY, 10166, US

(21) Appl. No.: 12/270,239

(22) Filed: Nov. 13, 2008

(30) Foreign Application Priority Data
Nov. 13, 2007 (CL) 03259 13.11.07
Apr. 10, 2008 (CL) 1023 2008

(51) Int. Cl. A63F 13/06

(52) U.S. Cl. 463/38

(57) ABSTRACT

One embodiment of the present invention is directed to a video game controller with a fan. In one example, the fan may be controlled to blow air on the game player based at least in part upon action taking place in the video game.

### RELATED APPLICATIONS

This application claims the benefit of Chilean application 03259 13.11.07, filed Nov. 13, 2007. This application also claims the benefit of Chilean application 1023 2008, filed Apr. 10, 2008. Each of the aforementioned applications is incorporated herein by reference in its entirety.

### FIELD OF THE INVENTION

One embodiment of the present invention is directed to a video game controller with a fan.

For the purposes of describing and claiming the present invention the term “video game” is intended to include hardware (e.g., a game console, a computer) and/or game instructions (e.g., software, firmware). In one example, the game instructions may be embodied on a magnetic disc, on an optical disc, in a solid-state memory device or on/in any other computer readable medium. BACKGROUND OF THE INVENTION

U.S. Pat. No. 7,347,815, entitled METHOD AND APPARATUS FOR CONVERTING SENSE-PERCEIVED THOUGHTS AND ACTIONS INTO PHYSICAL SENSORY STIMULATION, issued Mar. 25, 2008 in the name of Serbanescu.

U.S. Pat. No. 6,824,468, entitled FORCE FEEDBACK MECHANISM FOR GAMEPAD DEVICE, issued Nov. 30, 2004 in the name of Murzanski, et al.

U.S. Pat. No. 5,734,373, entitled METHOD AND APPARATUS FOR CONTROLLING FORCE FEEDBACK INTERFACE SYSTEMS UTILIZING A HOST COMPUTER, issued Mar. 31, 1998 in the name of Rosenberg, et al.

U.S. Patent Publication 2008/0207317, entitled GAME CONTROLLER WITH TACTILE FEEDBACK, published Aug. 28, 2008 in the name of Tetterington.

U.S. Patent Publication 2005/0269769, entitled HANDHELD CONTROLLER, published Dec. 8, 2005 in the name of Naghi et al.

### BRIEF DESCRIPTION OF THE DRAWINGS

FIG. 1 shows a perspective view of a game controller (e.g., hand-held type) according to an embodiment of the present invention;

FIG. 2 shows another perspective view of the game controller of FIG. 1 (wherein a fan portion (including motor 34, fan blade 35 and grill 36) is shown exploded);

FIG. 3 shows a perspective view of a game controller according to an embodiment of the present invention (wherein the fan portion is tilted relative to the controller body);

FIG. 4 shows a top view of a game controller according to an embodiment of the present invention;

FIGS. 5-7 show, respectively, a front view, a rear view and a side view of a game controller according to embodiments of the present invention;

FIG. 8 shows a perspective view of a game controller according to an embodiment of the present invention;

FIG. 9 shows another perspective view of the game controller of FIG. 8 (wherein a fan portion (and its mounting mechanism) are shown detached from the game controller body);

FIG. 10 shows a perspective view of a game controller (e.g., steering-wheel type) according to an embodiment of the present invention;

FIG. 11 shows another perspective view of the game controller of FIG. 10 (wherein a fan portion (including motor, fan blade and grill) is shown exploded);

FIGS. 12-16 show, respectively, a rear view, a front view, a side view, a top view and a bottom view of a game controller according to embodiments of the present invention;

FIG. 17 shows a perspective view of a game controller element (brake and accelerator type) according to an embodiment of the present invention (in one example, this element (brake and accelerator type) may be used in conjunction with the steering-wheel type game controller); and

FIG. 18 shows a more detailed view of the exploded fan portion shown in FIG. 11 (this view includes motor 305, fan blade 308 and grill 303).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive. Further, the figures are not necessarily to scale, some features may be exaggerated to show details of particular components (and any size, material and similar details shown in the figures are, of course, intended to be illustrative and not restrictive). Therefore, specific structural and functional details disclosed herein are not to be interpreted as limiting, but merely as a representative basis for teaching one skilled in the art to variously employ the present invention.

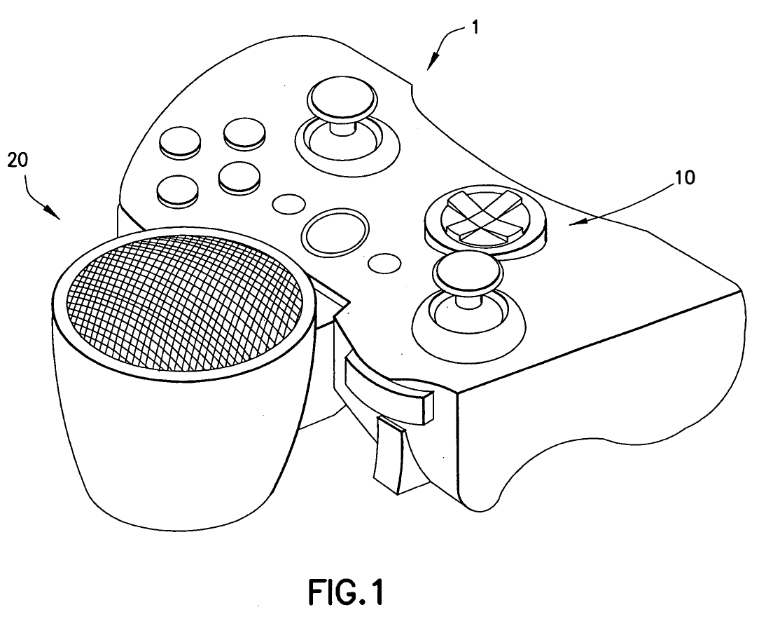

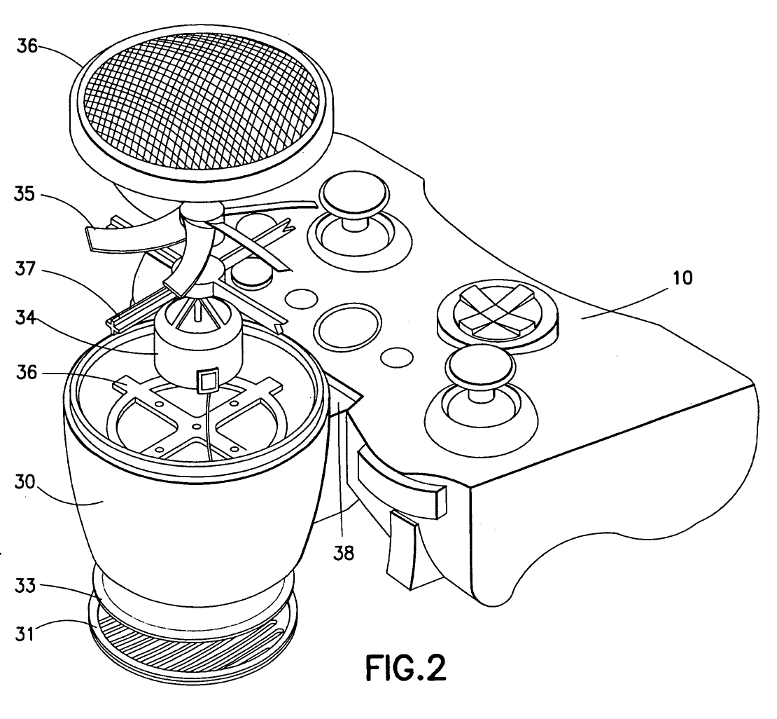

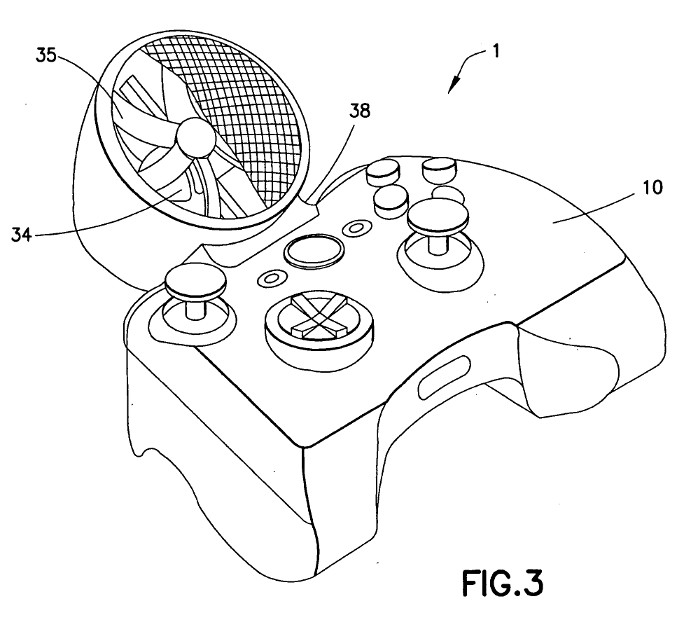

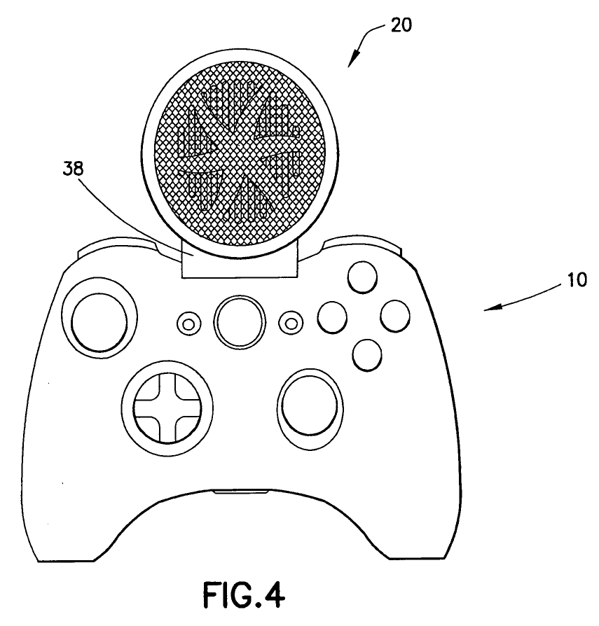

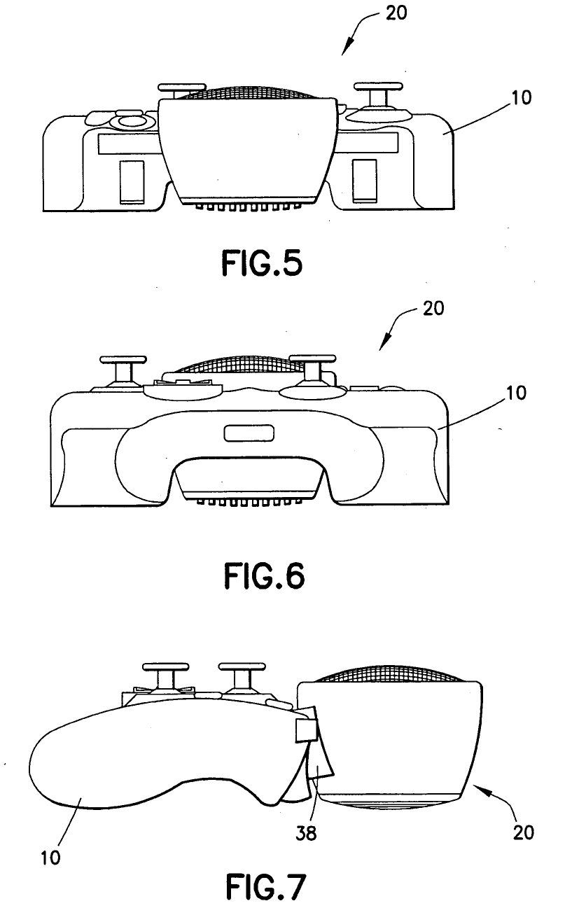

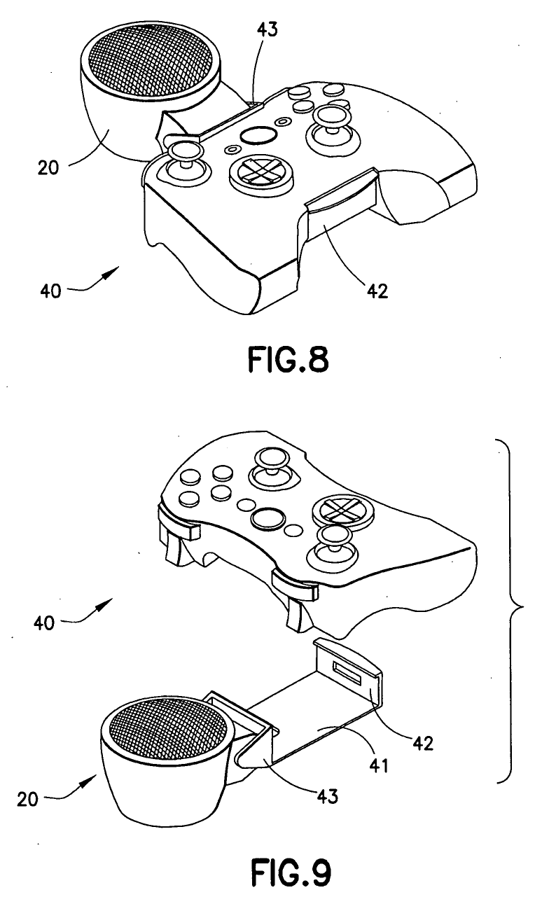

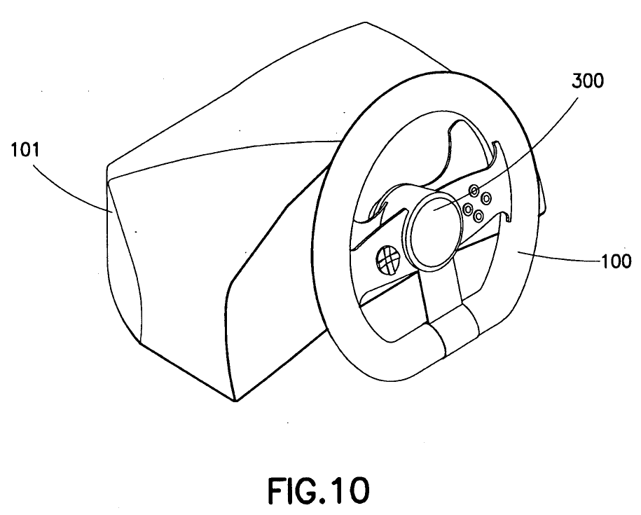

In various embodiments, a hand-held controller for a video game is provided (see, e.g., FIGS. 1-9). In one example, the controller 1 may comprise: a hand-held controller body 10; at least one input mechanism attached to the hand-held controller body, wherein the input mechanism receives input from a game player using the controller and wherein the input mechanism is operatively connected to the video game in order to control action taking place in the video game; a fan 20 attached to the hand-held controller body, wherein the fan is configured to blow air on the game player; and a fan control mechanism that controls the fan; wherein the fan control mechanism is operatively connected to the video game and to the fan to control the air blown on the game player based at least in part upon action taking place in the video game.

In one example, the controller may operatively communicate with the video game via a wireless connection.

In another example, the controller may operatively communicate with the video game via a wired connection.

In another example, the fan may comprise a motor and a fan blade.

In another example, air blown on the game player may be controlled by controlling (e.g., variably controlling) a speed of the fan blade and/or a pitch of the fan blade.

In another example, air blown on the game player may be controlled by controlling (e.g., variably controlling) a volume of the air blown on the game player, a speed of the air blown on the game player and/or a direction of the air blown on the game player.

In another example, the air blown on the game player may be controlled by being either on or off.

In another example, the air may be blown onto the game player's face and/or body and/or arms and/or legs.

In another example, the video game may be played using a device selected from the group including (but not limited to): a video game console and a computer.

In another example, the computer may be a personal computer.

In another example, output from the video game may be displayed on a video device.

In another example, the video device may be selected from the group including (but not limited to): a television and a monitor.

In another example, the fan may be attached to the hand-held controller body by being integrated within the hand-held controller body.

In another example, the fan may be attached to the hand-held controller body by being mounted (e.g., removably mounted) to an exterior of the hand-held controller body.

In another example, the fan may be attached to the hand-held controller body by being mounted (e.g., removably mounted) to an exterior of the hand-held controller body using one or more clip(s), spring(s), snap(s), hook-and-loop fastener(s) or the like.

In another example, the action taking place in the video game upon which the air blown on the game player is based may be the same action as the action controlled by the input mechanism.

In another example, the action taking place in the video game upon which the air blown on the game player is based may be different from the action controlled by the input mechanism.

In another example, the video game may comprise software.

In another example, the input mechanism may operatively communicate with the software.

In another example, the fan control mechanism may operatively communicate with the software.

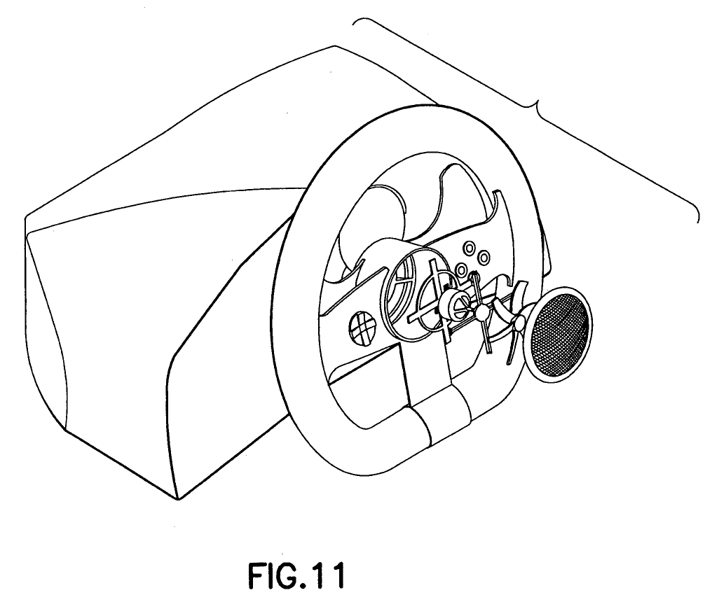

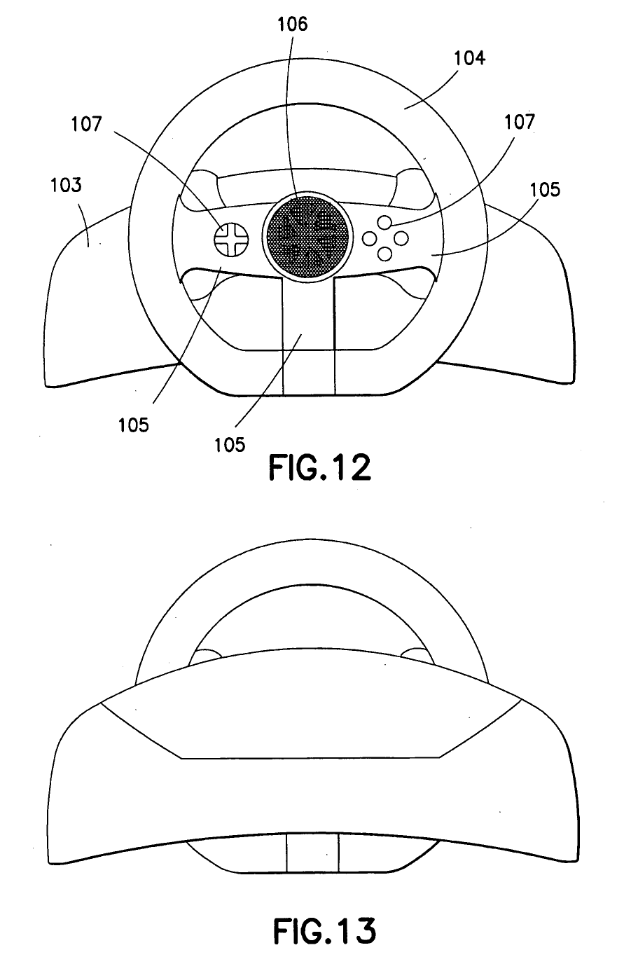

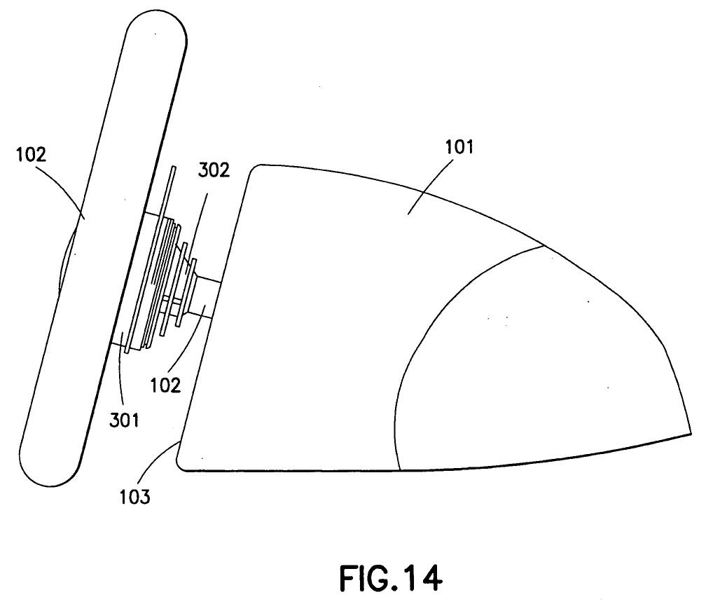

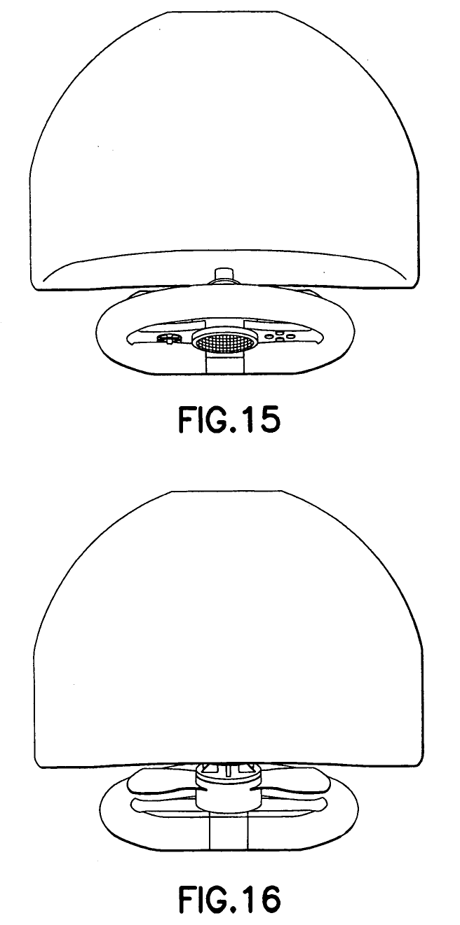

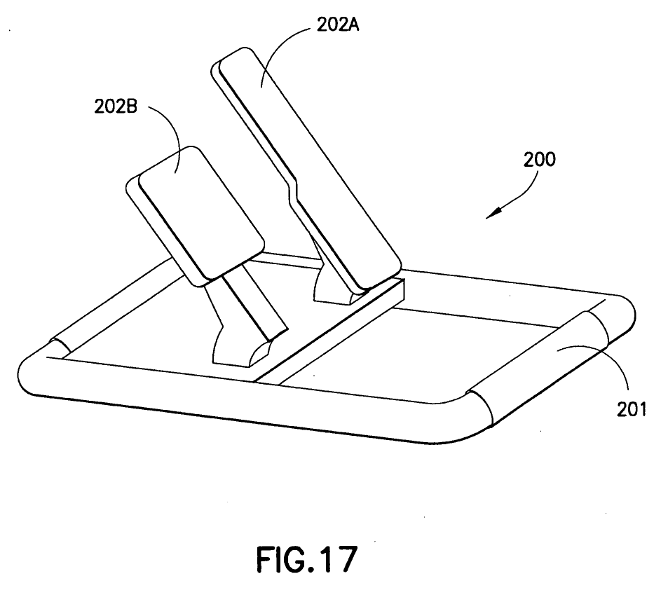

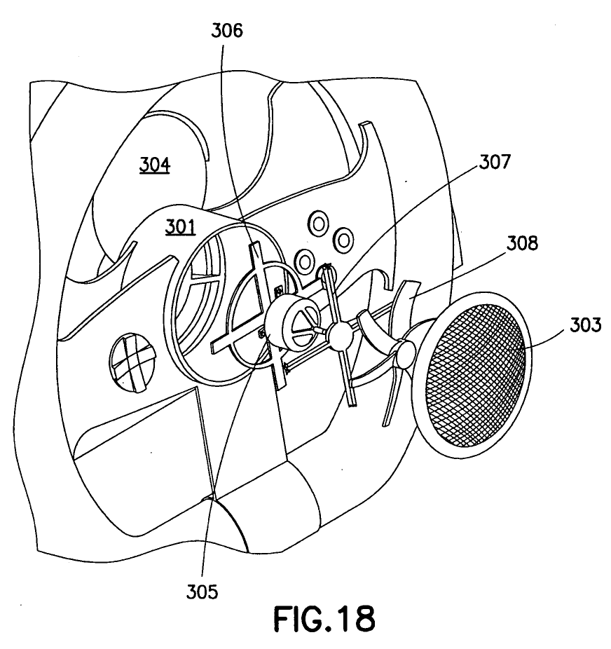

In various embodiments, a steering-wheel type controller for a video game is provided (see, e.g., FIGS. 10-18). In one example, the controller may comprise: a controller body 101 including a steering-wheel mechanism 100, wherein the steering-wheel mechanism receives input from a game player using the controller and wherein the steering-wheel mechanism is operatively connected to the video game in order to control action taking place in the video game; an accelerator mechanism 202A, wherein the accelerator mechanism receives input from the game player using the controller and wherein the accelerator mechanism is operatively connected to the video game in order to control action taking place in the video game; a brake mechanism 202B, wherein the brake mechanism receives input from the game player using the controller and wherein the brake mechanism is operatively connected to the video game in order to control action taking place in the video game; a fan 300 attached to the controller body, wherein the fan is configured to blow air on the game player; and a fan control mechanism that controls the fan; wherein the fan control mechanism is operatively connected to the video game and to the fan to control the air blown on the game player based at least in part upon action taking place in the video game.

In one example, the controller may operatively communicate with the video game via a wireless connection.

In another example, the controller may operatively communicate with the video game via a wired connection.

In another example, the fan may comprise a motor and a fan blade.

In another example, air blown on the game player may be controlled by controlling (e.g., variably controlling) a speed of the fan blade and/or a pitch of the fan blade.

In another example, air blown on the game player may be controlled by controlling (e.g., variably controlling) a volume of the air blown on the game player (e.g., related to acceleration/braking), a speed of the air blown on the game player (e.g., related to acceleration/braking) and/or a direction of the air blown on the game player (e.g., related to steering).

In another example, the air blown on the game player may be controlled by being either on or off.

In another example, the air may be blown onto the game player's face and/or body and/or arms and/or legs.

In another example, the video game may be played using a device selected from the group including (but not limited to): a video game console and a computer.

In another example, the computer may be a personal computer.

In another example, output from the video game may be displayed on a video device.

In another example, the video device may be selected from the group including (but not limited to): a television and a monitor.

In another example, the fan may be attached to the controller body by being integrated within the controller body.

In another example, the fan may be attached to the controller body by being mounted (e.g., removably mounted) to an exterior of the controller body.

In another example, the fan may be attached to the controller body by being mounted (e.g., removably mounted) to an exterior of the controller body using one or more clip(s), spring(s), snap(s), hook-and-loop fastener(s) or the like.

In another example, the fan may be disposed on or in the hub of the steering-wheel.

In another example, the action taking place in the video game upon which the air blown on the game player is based may be the same action as the action controlled by at least one of the steering-wheel mechanism, the accelerator mechanism and the brake mechanism.

In another example, the action taking place in the video game upon which the air blown on the game player is based may be different from the action controlled by at least one of the steering-wheel mechanism, the accelerator mechanism and the brake mechanism.

In another example, the video game may comprise software.

In another example, the input mechanism may operatively communicate with the software.

In another example, the fan control mechanism may operatively communicate with the software.

In another example, a tilt and/or angle of the fan (e.g., relative to the controller) may be variable.

In another example, any variable control over air blown on a game player described herein may be essentially infinitely variable (e.g., without predefined intermediate speeds, volumes, directions, or the like).

In another example, any variable control over air blown on a game player described herein may utilize predefined intermediate speeds, volumes, directions, or the like.

In another example, any variable control over air blown on a game player described herein may be essentially on or off.

In another example, any variable control over fan tilt/angle described herein may be essentially infinitely variable (e.g., without predefined intermediate detents or the like).

In another example, any variable control over fan tilt/angle described herein may utilize intermediate detents or the like).

For the purposes of this disclosure, a computer readable medium is a medium that stores computer data/instructions in machine readable form. By way of example, and not limitation, a computer readable medium can comprise computer storage media as well as communication media, methods or signals. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to tangibly store the desired information and which can be accessed by the computer.

Further, the present invention may, of course, be implemented using any appropriate computer readable medium, computer hardware and/or computer software. In this regard, those of ordinary skill in the art are well versed in the type of computer hardware that may be used (e.g., a personal computer (“PC”), a network (e.g., an intranet and/or the Internet)), the type of computer programming techniques that may be used (e.g., object oriented programming), and the type of computer programming languages that may be used (e.g., C++, Basic). The aforementioned examples are, of course, illustrative and not restrictive.

While a number of embodiments of the present invention have been described, it is understood that these embodiments are illustrative only, and not restrictive, and that many modifications may become apparent to those of ordinary skill in the art. For example, certain methods may be “computer implementable” or “computer implemented.” In this regard, it is noted that while such methods can be implemented using a computer, the methods do not necessarily have to be implemented using a computer. Also, to the extent that such methods are implemented using a computer, not every step must necessarily be implemented using a computer. Further, any steps described herein may be carried out in any desired order (and any steps may be added and/or deleted).

In another embodiment, the present invention provides a manual control panel for video game systems, capable of emitting controlled airflows for each video game's software to create various effects, such as air displacement, speed and wind, during its operation and of directing them toward the user's face. A controlled airflow generation system may be incorporated in the manual control panel and may be permanently attached to said manual control panel through an articulated assembly medium.

In another embodiment, the present invention provides a manual control panel for video game systems, capable of emitting controlled airflows for each video game's software to create various effects, such as air displacement, speed and wind, during its operation and of directing them toward the user's face, characterized in that a controlled airflow generation system is incorporated in said manual control panel and is permanently attached to said manual control panel through an articulated assembly medium.

In another embodiment, the present invention provides a manual control panel for video game systems, capable of emitting controlled airflows for each video game's software to create various effects, such as air displacement, speed and wind, during its operation and of directing them toward the user's face, further characterized in that said manual control panel consists of a casing that has an upper surface with command buttons, a lower surface, a rear surface that faces the user, a front surface opposite the rear one.

In another embodiment, the present invention provides a manual control panel for video game systems, capable of emitting controlled airflows for each video game's software to create various effects, such as air displacement, speed and wind, during its operation and of directing them toward the user's face, further characterized in that said controlled airflow generation system consists of a casing that houses a motor, propeller and particle filter.

In another embodiment, the present invention provides a manual control panel for video game systems, capable of emitting controlled airflows for each video game's software to create various effects, such as air displacement, speed and wind, during its operation and of directing them toward the user's face, further characterized in that said casing is a cylindrical body with both ends open and presenting threaded elements on its interior perimetral edges, one of said ends presenting a perforated cover to admit air into the interior of the casing, while its opposite end presents a screen-like cover to emit controlled airflows that are formed inside the casing.

In another embodiment, the present invention provides a manual control panel for video game systems, capable of emitting controlled airflows for each video game's software to create various effects, such as air displacement, speed and wind, during its operation and of directing them toward the user's face, according to further characterized in that said perforated cover and said screen-like cover present threaded elements on their exterior perimetral edges, through which they are mounted on the ends of the casing by means of complementary threaded elements present in said internal perimetral edges of the casing.

In another embodiment, the present invention provides a manual control panel for video game systems, capable of emitting controlled airflows for each video game's software to create various effects, such as air displacement, speed and wind, during its operation and of directing them toward the user's face, further characterized in that said screen-like cover, present in one of the ends of the casing, consists of a screen with a hexagonal mesh.

In another embodiment, the present invention provides a manual control panel for video game systems, capable of emitting controlled airflows for each video game's software to create various effects, such as air displacement, speed and wind, during its operation and of directing them toward the user's face, further characterized in that said motor housed in the interior of the casing is a brushless high-power electric motor, fed 12V through an internal cable.

In another embodiment, the present invention provides a manual control panel for video game systems, capable of emitting controlled airflows for each video game's software to create various effects, such as air displacement, speed and wind, during its operation and of directing them toward the user's face, further characterized in that said propeller has multiple blades and is functionally joined to said electric motor by means of a common axle.

In another embodiment, the present invention provides a manual control panel for video game systems, capable of emitting controlled airflows for each video game's software to create various effects, such as air displacement, speed and wind, during its operation and of directing them toward the user's face, further characterized in that said particle filter is circular, is removable for cleaning or replacement, is made of nonwoven polypropylene and is mounted on the air admission area of the casing through a rigid frame.

In another embodiment, the present invention provides a manual control panel for video game systems, capable of emitting controlled airflows for each video game's software to create various effects, such as air displacement, speed and wind, during its operation and of directing them toward the user's face, further characterized in that said articulated connection medium, which attaches said controlled airflow generation system to the video game manual control panel, consists of an articulated elbow with preset positioning and adjustable by means of a dentated system presenting an interior trough for the passage of a cable that feeds electricity to said airflow generation system.

In another embodiment, the present invention provides a manual control panel for video game systems, capable of emitting controlled airflows for each video game's software to create various effects, such as air displacement, speed and wind, during its operation and of directing them toward the user's face, further characterized in that the medium that allows for generation of articulated movement of the airflow generation system with respect to said manual control panel consists of an assembly system by means of articulation with extended and multidirectional range of movement, which allows for constant and simultaneous orientation of the airflow by means of an integrated electronic control system, always being able to maintain the user's face as the objective, regardless of the inclination of the control.

In another embodiment, the present invention provides a manual control panel for video game systems, capable of emitting controlled airflows for each video game's software to create various effects, such as air displacement, speed and wind, during its operation and of directing them toward the user's face, further characterized in that said articulated connection medium is attached to the manual control panel on the front surface of said control panel.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, characterized in that said airflow generation system has a removable medium for coupling to said manual control panel, has a medium that allows for generation of articulated movement of the airflow generation system with respect to said manual control panel and has a medium for connection to the console for electrical feeding.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said controlled airflow generation system consists of a casing that houses a motor, propeller and particle filter.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said casing is a cylindrical body with both ends open and presenting threaded elements on its interior perimetral edges, one of said ends presenting a perforated cover to admit air into the interior of the casing, while its opposite end presents a screen-like cover to emit controlled airflows that are formed inside the casing.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said perforated cover and said screen-like cover present threaded elements on their exterior perimetral edges, through which they are mounted on the ends of the casing by means of complementary threaded elements present in said internal perimetral edges of the casing.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said screen-like cover, present in one of the ends of the casing, consists of a screen with a hexagonal mesh.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said motor, housed in the interior of the casing, is a brushless high-power electric motor, fed 12V.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said propeller has multiple blades and is functionally joined to said electric motor.

In another embodiment, the present invention provides an accessory system for video game manual controls, capable of generating controlled airflows for each video game's software to create various effects, such as air displacement, speed and wind, during its operation and of directing them toward the user' s face, capable of being connected temporarily or permanently to a video game manual control panel, further characterized in that said particle filter is circular, is removable for cleaning or replacement, is made of nonwoven polypropylene and is mounted on the air admission area of the casing through a rigid frame.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that said detachable medium for coupling the airflow generation system to said manual control panel is comprised of a pressure clip connector made of injected polymer.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that the medium that allows for generation of articulated movement of the airflow generation system with respect to said manual control panel consists of an articulated elbow with programmed positioning by means of a dentated system, which is placed between said clip connector and said casing.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that the medium that allows for generation of articulated movement of the airflow generation system with respect to said manual control panel consists of an assembly system by means of articulation with extended and multidirectional range of movement, which allows for constant and simultaneous orientation of the airflow by means of an integrated electronic control system, always maintaining the user's face as the objective, regardless of the inclination of the control.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that the medium for connection of the airflow generation system to said control panel for electrical feeding includes an external connection cable, which is connected to the console.

In another embodiment, the present invention provides an accessory system for video game manual controls, capable of generating controlled airflows for each video game's software to create various effects, such as air displacement, speed and wind, during its operation and of directing them toward the user's face, capable of being connected temporarily or permanently to a video game manual control panel, further characterized in that the airflow generation system includes an assembly system by means of articulation with extended and multidirectional range of movement, which allows for constant and simultaneous orientation of the airflow by means of an integrated electronic control system, always maintaining the user's face as the objective, regardless of the inclination of the control.

In another embodiment, the present invention provides an accessory device for computers or video game consoles, which consists of a steering wheel or handle control system, with incorporation in said steering wheel or handle control system of a controlled airflow generation system capable of emitting said flows to simulate speed effects during its operation and of directing them toward the user's face.

In another embodiment, the present invention provides an accessory device for computers or video game consoles, which consists of a steering wheel or handle control system, characterized in that said steering wheel control system has incorporated within it a controlled airflow generation system capable of emitting said flows to simulate speed effects during its operation and of directing them toward the user's face.

In another embodiment, the present invention provides an accessory device for computers or video game consoles, which consists of a steering wheel or handle control system, further characterized in that said steering wheel control system consists of a platform or base with a steering wheel and a set of control pedals.

In another embodiment, the present invention provides an accessory device for computers or video game consoles, which consists of a steering wheel or handle control system, further characterized in that said controlled airflow generation system consists of a casing that houses a motor, propeller and particle filter, said casing being placed in said steering wheel, which is attached to said platform.

In another embodiment, the present invention provides an accessory device for computers or video game consoles, which consists of a steering wheel or handle control system, further characterized in that said casing is a cylindrical body with both ends open and presenting threaded elements on their interior perimetral edges, one of said ends presenting a conical-shaped cover, perforated to admit air to the interior of the casing, while its opposite end presents a screen-like cover to emit controlled airflows that are formed inside the casing.

In another embodiment, the present invention provides an accessory device for computers or video game consoles, which consists of a steering wheel or handle control system, further characterized in that said perforated cover and said air-diffusion cover present threaded elements on their exterior perimetral edges, through which they are mounted on the ends of the casing by means of complementary threaded elements present in said internal perimetral edges of the casing.

In another embodiment, the present invention provides an accessory device for computers or video game consoles, which consists of a steering wheel or handle control system, further characterized in that said screen-like cover present in one of the ends of the casing consists of a diffusion screen.

In another embodiment, the present invention provides an accessory device for computers or video game consoles, which consists of a steering wheel or handle control system, further characterized in that said motor housed in the interior of the casing is a brushless high-power electric motor with channeled electrical feeding in its interior.

In another embodiment, the present invention provides an accessory device for computers or video game consoles, which consists of a steering wheel or handle control system, further characterized in that said propeller has multiple blades and is functionally joined to said electric motor.

In another embodiment, the present invention provides an accessory device for computers or video game consoles, which consists of a steering wheel or handle control system, further characterized in that said particle filter is circular, is removable for cleaning or replacement, is made of nonwoven polypropylene and is mounted on the air admission area of the casing through a rigid frame.

In another embodiment, the present invention provides an accessory device for computers or video game consoles, which consists of a steering wheel or handle control system, further characterized in that the platform or base is a body having a flat lower surface and a rear surface that has an axle by which it is attached to the center of the steering wheel.

In another embodiment, the present invention provides an accessory device for computers or video game consoles, which consists of a steering wheel or handle control system, further characterized in that said steering wheel contains an element that reproduces the shape of a vehicle handlebar, which is composed of a ring-shaped handpiece and is attached by radial extensions to a central panel that incorporates buttons to control various functions in each video game.

In another embodiment, the present invention provides an accessory device for computers or video game consoles, which consists of a steering wheel or handle control system, further characterized in that said set of control pedals includes a base that contains 2 pedals and is attached to the platform by means of a finished cable with a telephone-like multi-contact connector plug.

Various embodiments of the present invention are also described in the Spanish language versions of the two priority applications at the following pages.

What is claimed is:

1. A controller for a video game, comprising:
a hand-held controller body;
at least one input mechanism attached to the hand-held controller body, wherein the input mechanism receives input from a game player using the controller and wherein the input mechanism is operatively connected to the video game in order to control action taking place in the video game;
a fan attached to the hand-held controller body, wherein the fan is configured to blow air on the game player; and
a fan control mechanism that controls the fan;
wherein the fan control mechanism is operatively connected to the video game and to the fan to control the air blown on the game player based at least in part upon action taking place in the video game.

2. The controller of claim 1, wherein the video game is played using a device selected from the group consisting of: a video game console and a computer.

3. The controller of claim 2, wherein the computer is a personal computer.

4. The controller of claim 1, wherein output from the video game is displayed on a video device.

5. The controller of claim 4, wherein the video device is selected from the group consisting of: a television and a monitor.

6. The controller of claim 1, wherein the fan is attached to the hand-held controller body by being integrated within the hand-held controller body.

7. The controller of claim 1, wherein the fan is attached to the hand-held controller body by being mounted to an exterior of the hand-held controller body.

8. The controller of claim 1, wherein the action taking place in the video game upon which the air blown on the game player is based is the same action as the action controlled by the input mechanism.

9. The controller of claim 1, wherein the action taking place in the video game upon which the air blown on the game player is based is different from the action controlled by the input mechanism.

10. The controller of claim 1, wherein the video game comprises software.

11. A controller for a video game, comprising:
a controller body including a steering-wheel mechanism, wherein the steering-wheel mechanism receives input from a game player using the controller and wherein the steering-wheel mechanism is operatively connected to the video game in order to control action taking place in the video game;
an accelerator mechanism, wherein the accelerator mechanism receives input from the game player using the controller and wherein the accelerator mechanism is operatively connected to the video game in order to control action taking place in the video game;
a brake mechanism, wherein the brake mechanism receives input from the game player using the controller and wherein the brake mechanism is operatively connected to the video game in order to control action taking place in the video game;
a fan attached to the controller body, wherein the fan is configured to blow air on the game player; and
a fan control mechanism that controls the fan;
wherein the fan control mechanism is operatively connected to the video game and to the fan to control the air blown on the game player based at least in part upon action taking place in the video game.

12. The controller of claim 11, wherein the video game is played using a device selected from the group consisting of: a video game console and a computer.

13. The controller of claim 12, wherein the computer is a personal computer.

14. The controller of claim 11, wherein output from the video game is displayed on a video device.

15. The controller of claim 14, wherein the video device is selected from the group consisting of: a television and a monitor.

16. The controller of claim 11, wherein the fan is attached to the controller body by being integrated within the controller body.

17. The controller of claim 11, wherein the fan is attached to the controller body by being mounted to an exterior of the controller body.

18. The controller of claim 11, wherein the action taking place in the video game upon which the air blown on the game player is based is the same action as the action controlled by at least one of the steering-wheel mechanism, the accelerator mechanism and the brake mechanism.

19. The controller of claim 11, wherein the action taking place in the video game upon which the air blown on the game player is based is different from the action controlled by at least one of the steering-wheel mechanism, the accelerator mechanism and the brake mechanism.

20. The controller of claim 11, wherein the video game comprises software.
